(19) United States
(12) Patent Application Publication
(10) Pub. No.: US 2013/0230830 A1
(43) Pub. Date: Sep. 5, 2013

(54) INFORMATION OUTPUTTING APPARATUS AND A METHOD FOR OUTPUTTING INFORMATION

(71) Applicant: CANON KABUSHIKI KAISHA, Tokyo (JP)

(72) Inventors: Xin Liu, Bei Jing (CN); Xuyu Zhao, Bei Jing (CN)

(73) Assignee: CANON KABUSHIKI KAISHA, Tokyo (JP)

(21) Appl. No.: 13/774,872

(22) Filed: Feb. 22, 2013

(30) Foreign Application Priority Data
Feb. 27, 2012 (CN) 20120046409.8

(51) Int. Cl. G09B 5/00

(52) U.S. Cl. CPC G09B 5/00
USPC 434/156

(57) ABSTRACT

An information outputting apparatus for outputting a first information, and a second information including a plurality of information units, comprising: storage means operable to store an information classification library including a plurality of information units and a classification status for each of the information unit; classification means operable to determine the classification status of each information unit in the second information according to the information classification library; output means operable to synchronically output the first information and the information units in the second information based on the classification results in said classification means; and classification control means operable to change real time the classification status for at least one information unit in the information classification library while the first information is output.

This application claims priority from Chinese Patent Application No. 201210046409.8 filed Feb. 27, 2012, which is hereby incorporated by reference herein in its entirety.

### BACKGROUND OF THE INVENTION

1. Field of the Invention

The present invention generally relates to an information outputting apparatus and a method for outputting information used in the information outputting apparatus.

2. Description of the Related Art

Currently, an information outputting apparatus such as an audio player (MP3 player) and a video player (DVD), and so on is widely used by a learner in foreign language learning, especially listening and oral exercise. A problem confronted by the learner is that if an audio and/or video stream in a foreign language is played without any information facilitating comprehension and pronunciation, it is possible that the learner cannot understand the meaning of the audio and/or video stream and pronounce correctly even if he listened and/or watched for many times. To overcome the problem, a script corresponding to the audio or video stream is displayed to facilitate the learner's comprehension of the information while the audio or video information is played. The script may comprise a text including a plurality of sentences corresponding to the stream, or include notation of pronunciations for the words in the stream. However, if all information in the corresponding script is displayed to the learner, the learner may complain that displaying all scripts reduces difficulty of the learning. The learner may prefer to display merely part of the script or a certain type of script. For example, if certain words in a script are difficult and unfamiliar to him or he only desires that adjective words in the script are displayed, the words can be displayed without remaining part in the script being displayed. If he is not familiar with a certain field, for example, politics or sports, sentences in the certain field within the script can be displayed.

In order to display a part of a script, a method is provided in a United State patent application No.: US2009/0162818. In the method of the application, a content which is related with an audio stream will be filtered based on a filter vocabulary library. A translation of a word which is in said content but not in the filter vocabulary library is displayed synchronically with the audio stream. However, in the method, a user cannot choose to display the whole sentence which includes said word. Further, since the filter vocabulary library is preset, a user cannot conveniently adjust the filter vocabulary library, such as insert familiar words to the library or delete unknown words from the library, while the content is played. Additionally, the method focuses on providing the translation for the learning content after filtration. It does not focus on providing a convenient and effective method for practicing listening.

To display the script in a certain field, an apparatus for receiving and processing a broadcast signal is proposed in a United State patent application No.: US2010/0071002. With the apparatus of the application, the broadcast signal containing digital caption information is received. An explanation of a terminology which is both in the caption and in a preset terminology list is displayed synchronically while the broadcast is played. In the apparatus, the preset terminology list is created based on popular levels of words or fields of words. However, the terminology list is prepared in the manufacturing of the apparatus and cannot be changed after that. The application No.: US 2010/0071002 does not mention how to adjust the preset terminology list real time while the broadcast is playing. Therefore, it is inconvenient to the user because the user's comprehension of a foreign language is changeable with lapse of time. Such fixed terminology list will become useless once the user's language ability is improved.

FIG. 15 is a function block diagram of a conventional information outputting apparatus according to the application Nos.: US 2009/0162818 and US 2010/0071002. As shown in FIG. 15, the information outputting apparatus comprises a script classification unit 1503, a predefined library storage unit 1504, and an output unit 1505. A script corresponding to a stream is classified by the script classification unit 1503 on the basis of a predefined information classification library stored in a predefined library storage unit 1504. The output of the stream and part of the script is performed by the output unit 1505 on the basis of the classification result of the script classification unit 1503. During the output of the audio and/or video stream as well as the words in the script based on the classification result, the displaying of the words in the script cannot be changed or updated. The user cannot customize the predefined information classification library on the basis of his language ability, and the efficiency of language learning will be limited.

### SUMMARY OF THE INVENTION

The present invention provides an information outputting apparatus which can provide a convenient and effective method for the user to learning language. With the information outputting apparatus, the user can customize the classification status for a certain words in the information classification library real time during his language learning and this customization will affect immediately displaying of the script in playing learning materials.

In one aspect of the present invention, an information outputting apparatus for outputting a first information and a second information including a plurality of information units is provided, comprising: storage means operable to store an information classification library including a plurality of the information units and a classification status for each of the information unit; classification means operable to determine the classification status of each information unit in the second information according to the information classification library; output means operable to synchronically output the first information and the information units in the second information based on the classification results in said classification means; and classification control means operable to change real time the classification status for at least one information unit in the information classification library while the first information is output.

In another aspect, a method for outputting a first information and a second information including a plurality of information units through an information outputting apparatus is provided, comprising: classification step of determining a classification status of each information unit in the second information according to an information classification library which includes a plurality of the information units and a classification status for each of the information unit; outputting step of synchronically outputting the first information and the information units in the second information based on the classification results of said classification step; and classification control step of changing real time the classification status for at least one information unit in the information classification library while the first information is output in the outputting step.

With the information outputting apparatus and the method for output information, the user can customize the classification status for certain words in the information classification library real time during his language learning and this customization will affect immediately displaying of the script in playing learning materials.

Further features of the present invention will become apparent from the following description of exemplary embodiments with reference to the attached drawings.

### BRIEF DESCRIPTION OF THE DRAWINGS

FIG. 1 is a block diagram showing a hardware configuration of a computer system which can implement the information outputting apparatus of the present invention.

FIG. 2 is a schematic diagram of an example of the information outputting apparatus according to the present invention.

FIG. 3 is a function block diagram of an information outputting apparatus according to a first embodiment of the present invention.

FIG. 4 is a flowchart of information outputting procedure in the information outputting apparatus according to the first embodiment of the present invention.

FIG. 5 is a schematic diagram of implementation example of the information outputting procedure according to the first embodiment.

FIG. 6 is a flowchart of classification control procedure during the information outputting procedure in the information outputting apparatus according to the first embodiment.

FIGS. 7A to 7C each is a schematic diagram of implementation example of the classification control procedure during the information outputting procedure in the information outputting apparatus according to the first embodiment.

FIG. 8 is a function block diagram of an information outputting apparatus according to a second embodiment of the present invention.

FIG. 9 is a flowchart of information outputting procedure in the information outputting apparatus according to the second embodiment of the present invention.

FIG. 10 is a flowchart of an implementation example of the classification control procedure in the case of a vibration sensor according to the second embodiment.

FIG. 11 is a function block diagram of an information outputting apparatus according to a third embodiment of the present invention.

FIG. 12 is a flowchart of information outputting procedure in the information outputting apparatus according to the third embodiment of the present invention.

FIG. 13 is a flowchart of classification control procedure during the information outputting procedure in the information outputting apparatus according to the third embodiment of the present invention.

FIG. 14 is a function block diagram of an information outputting apparatus according to a fourth embodiment of the present invention.

FIG. 15 is a function block diagram of a conventional information outputting apparatus.

### DESCRIPTION OF THE EMBODIMENTS

Preferred embodiments of the present invention will now be described in detail in accordance with the accompanying drawings. Note that the relative arrangement of components and shapes of devices in the embodiments are described merely as examples, and are not intended to limit the scope of the invention to these examples. Further, similar reference numerals and letters refer to similar items in the figures, and thus once an item is defined in one figure, it need not be discussed for following figures.

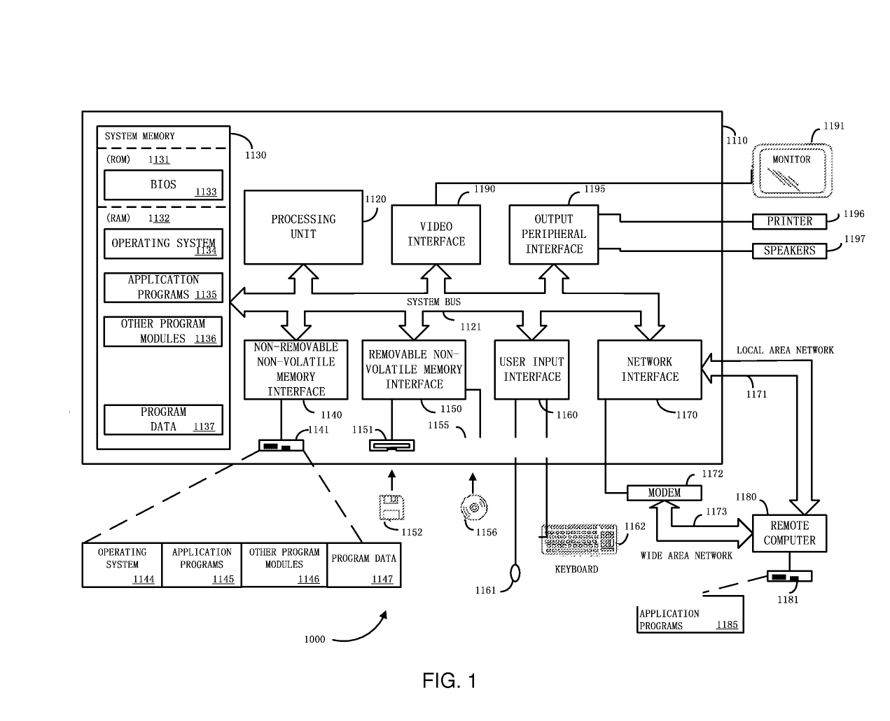

FIG. 1 is a block diagram showing a hardware configuration of a computer system 1000 which can implement the information outputting apparatus of the present invention.

As shown in FIG. 1, the computer system comprises a computer 1110. The computer 1110 comprises a processing unit 1120, a system memory 1130, non-removable non-volatile memory interface 1140, removable non-volatile memory interface 1150, user input interface 1160, network interface 1170, video interface 1190 and output peripheral interface 1195, which are connected via a system bus 1121.

The system memory 1130 comprises ROM (read-only memory) 1131 and RAM (random access memory) 1132. A BIOS (basic input output system) 1133 resides in the ROM 1131. An operating system 1134, application programs 1135, other program units 1136 and some program data 1137 reside in the RAM 1132.

A non-removable non-volatile memory 1141, such as a hard disk, is connected to the non-removable non-volatile memory interface 1140. The non-removable non-volatile memory 1141 can store an operating system 1144, application programs 1145, other program units 1146 and some program data 1147, for example.

Removable non-volatile memories, such as a floppy drive 1151 and a CD-ROM drive 1155, are connected to the removable non-volatile memory interface 1150. For example, a floppy disk 1152 can be inserted into the floppy drive 1151, and a CD (compact disk) 1156 can be inserted into the CD-ROM drive 1155.

Input devices, such as a mouse 1161 and a keyboard 1162, are connected to the user input interface 1160.

The computer 1110 can be connected to a remote computer 1180 by the network interface 1170. For example, the network interface 1170 can be connected to the remote computer 1180 via a local area network 1171. Alternatively, the network interface 1170 can be connected to a modem (modulator-demodulator) 1172, and the modem 1172 is connected to the remote computer 1180 via a wide area network 1173.

The remote computer 1180 may comprise a memory 1181, such as a hard disk, which stores remote application programs 1185.

The video interface 1190 is connected to a monitor 1191.

The output peripheral interface 1195 is connected to a printer 1196 and speakers 1197.

The computer system shown in FIG. 1 is merely illustrative and is in no way intended to limit the invention, its application, or uses.

The computer system shown in FIG. 1 may be implemented to any of the embodiments, either as a stand-alone computer, or as a processing system in an apparatus, possibly with one or more unnecessary components removed or with one or more additional components added.

(Example of the Information Outputting Apparatus)

The information outputting apparatus can be any device which can output audio and/or video information, such as a PDA (personal digital assistant), an mp3 player, a video player, a cell phone, an electronic-Book or a personal computer.

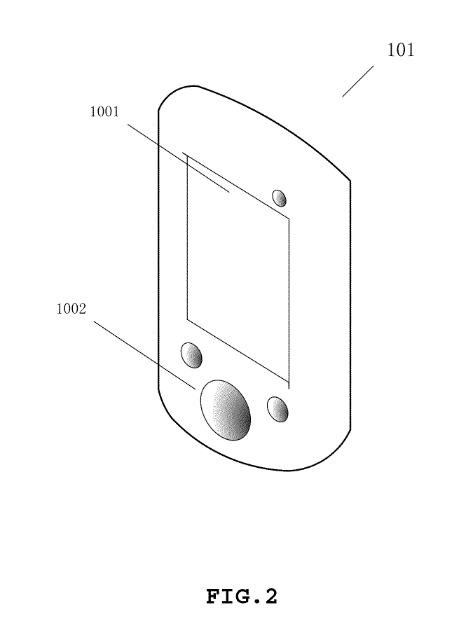

FIG. 2 takes a PDA as an example of the information outputting apparatus. FIG. 2 is a schematic diagram of an example of the information outputting apparatus according to the present invention. As shown in FIG. 2, the PDA 101 has a display panel 1001 through which a video stream or a script can be displayed. Preferably, the display panel 1001 is a touch display panel. A user can perform an operation and input an instruction by touching the touch display panel. Alternatively, the user can perform operation by any other way, for example, pressing keys and knobs 1002 shown in FIG. 2. The PDA 101 has a storage means (not shown) to store various data including an electronic dictionary, audio or video stream and the script. The PDA 101 has an interface (not shown) for inputting data such as an audio and/or video file and a script file in text format. Such interface can be a USB (Universal Serial Bus) interface. Alternatively, the PDA 101 may receive data wirelessly through WiFi or Bluetooth®.

Anyhow, FIG. 2 is merely an example of the information outputting apparatus. The information outputting apparatus is not limited to the PDA, but may be any device which can output audio and/or video information, such as an mp3 player, a video player, a cell phone, an electronic-Book or a personal computer. Further, the user's operation can be inputted through any other way than touching the panel or pressing the keys and knobs 1002. The user can perform operation through any other peripheral device, for example, a keyboard, a pointing device such as a mouse, or the like.

### First Embodiment

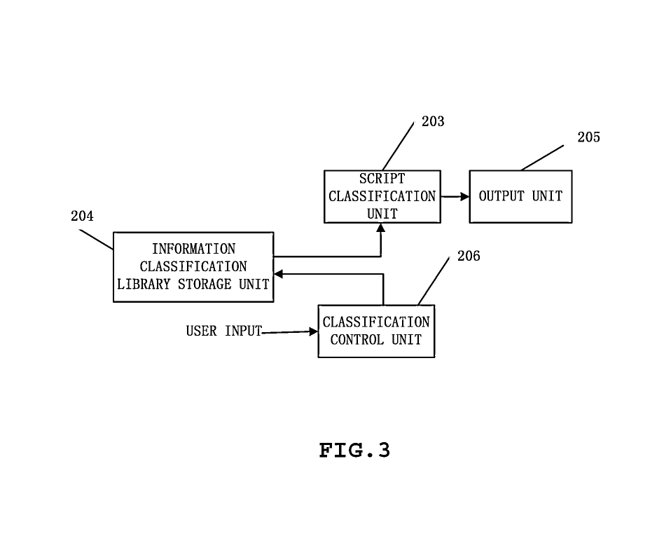

FIG. 3 is a function block diagram of the information outputting apparatus according to the first embodiment.

As shown in FIG. 3, the information outputting apparatus according to the first embodiment comprises a script classification unit 203, an information classification library storage unit 204, an output unit 205, a classification control unit 206.

The information classification library storage unit 204 is for storing an information classification library including words (information unit, the information unit can also be a character or a phrase) and classification status for each word. The information classification library may include a vocabulary in a dictionary, for example, “Longman Dictionary of Contemporary English”, or a vocabulary for a certain language test, for example, CET (College English test, a nationwide standard English test in China) 4. The classification status of a word can be determined on the basis of at least one classification rule. The classification rules for a word include, for example, a difficulty level, familiarity level, part of speech, field, or the like.

The difficulty level shows a degree of difficulty of the word. For example, if the word belongs to a vocabulary of CET 4, the difficulty level of the word can be set to 1. If the word belongs to a vocabulary of CET 6, the difficulty level of the word can be set to 2.

A familiarity level indicates a user's familiarity with a word. If the user is familiar with the word, the word can be set to familiar. If the user knows the meaning of the word but is unfamiliar with the pronunciation of the word, that is, cannot understand the word through listening, the word can be set to unfamiliarity level 1. For example, if the user knows a word “deal”, but cannot understand the word through listening, then the word “deal” can be set to the unfamiliarity level 1. If the user neither knows the meaning of the word nor understands the word through listening, the word can be set to unfamiliarity level 2. For example, if the user does not know the meaning of a word “clinch”, and cannot understand the word “clinch” through listening, the word “clinch” can be set to the unfamiliarity level 2.

Part of speech indicates that a word is an adjective, a noun, a verb, or the like. Field indicates that a word is related to sports, politics, technologies, cultures, or the like.

These classification rules can be used individually or in combination when determining the classification status of a word. For example, with respect to the word “congress”, the classification status can be that the difficult level is 2. Alternatively, the classification status for the word “congress” can be that the difficult level is 2, the part of speech is a noun, and the field is politics.

The information classification library in the information classification library storage unit 204 is utilized by the script classification unit 203 to classify words in a script corresponding to an audio and/or video stream being pre-stored in the information outputting apparatus or inputted through an input unit (not shown). That is, the script classification unit 203 determines the classification status of the words in the script on the basis of the information classification library. For example, with respect to the sentence ‘The IMF has warned of a “severe shock” to global financial markets if the US does not move quickly to increase its borrowing authority, adding pressure on Congress and the White House to clinch a deal on fiscal policy’, if the difficulty level is used as a classification rule in the information classification library, the classification status for each of the words in the sentence can be determined by looking up in the information classification library. After the classification, the result may be that the words at difficulty level 2 are “Congress”, “clinch”, and “fiscal”, and the remaining words are at difficulty level 1. If a word does not exist in the information classification library, the difficulty level of the word may be the highest level, for example, level 3. Optionally, if several classification rules are used in combination for the information classification library, the result may have several parameters. For example, with respect to the word “Congress”, the result is that difficulty level is 2, the field is politics, and so on.

The output unit 205 is for outputting an audio and/or video stream and the words in the script on the basis of the classification result of the script classification unit 203. The output unit 205 usually includes an audio output element (not shown) for outputting the audio stream and a display element (not shown) for displaying the video stream and the words in the script. With respect to the displaying of the words in the script, the display element can switch between a word mode in which merely part of words in the script is displayed on the basis of the classification results, and a whole sentence mode in which a whole sentence including the displayed words is displayed. Preferably, in the word mode, explanations of the displayed words may be displayed so as to facilitate the user's comprehension of the words.

The classification control unit 206 is for updating the information classification library real time while the audio and/or video stream is played. More specifically, the classification control unit 206 can change the classification status of a certain word in the information classification library stored in the information classification library storage unit 204 on the basis of a user's operation. On the basis of the updated information classification library, the script classification unit 203 can update classification of the script real time. In turn, the display of the words in the script can be changed accordingly.

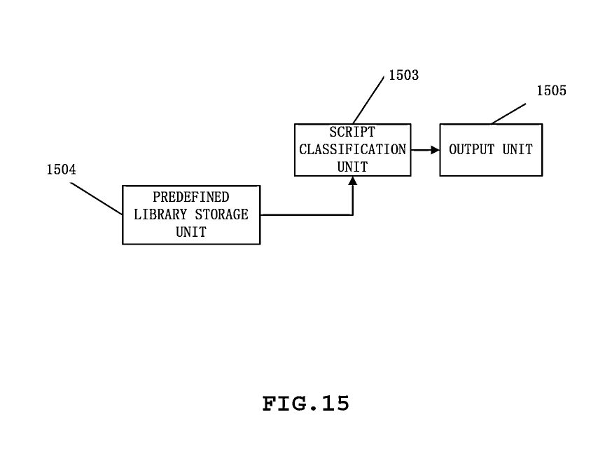

The difference between the information outputting apparatus of the present invention and the conventional information outputting apparatus as shown in FIG. 15 is that, the conventional information outputting apparatus has no classification control unit by which the information classification library can be changed dynamically real time while a stream is played. With such classification control unit 206 of the present invention, the information classification library can be changed real time according to the user's operation, so as to adaptively provide information classification library customized for different users, to enhance performance of the information outputting apparatus in language learning, and to improve the learning efficiency. Furthermore, the words in the script displayed in the output unit would also adaptively be different according to the preference and customization setting of different users, and different language learning phases of the same user.

Alternatively, the information outputting apparatus may have an information input unit (not shown) for receiving information including audio or video stream to be played and a script corresponding thereto. The information input unit processes the information received so as to make the script being synchronized with the stream. With the synchronization, the script can be played matching the timing of the stream simultaneously. The synchronization can be omitted if the stream and the script have already been synchronized when being inputted.

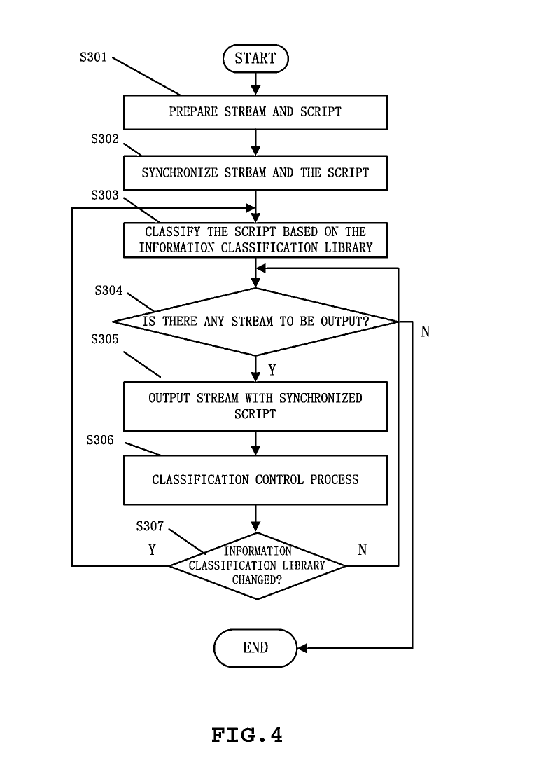

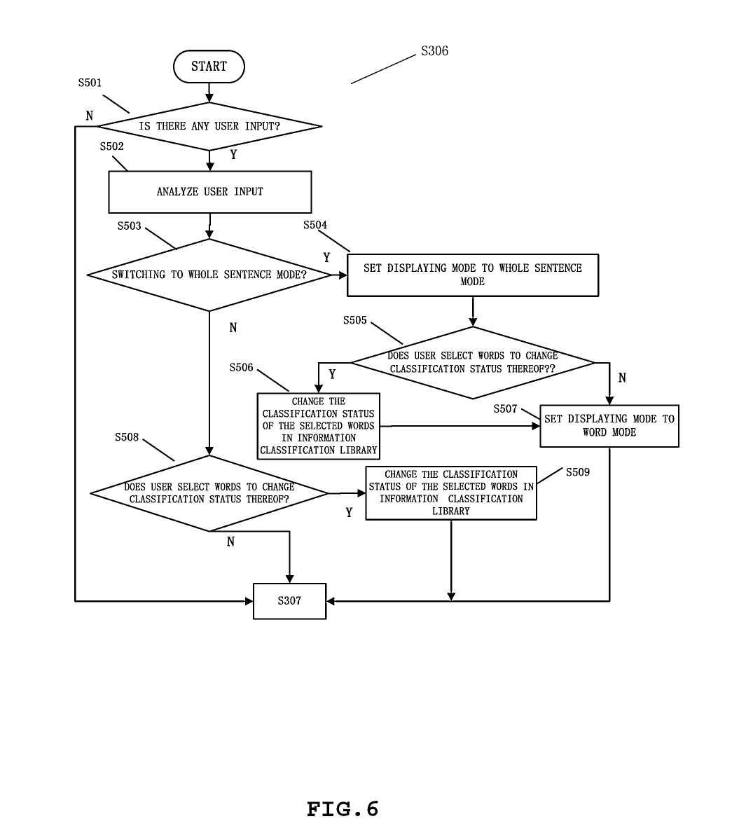

Now, details of the information outputting procedure according to the first embodiment of the present invention will be described with reference to FIGS. 4 and 6.

FIG. 4 is a flowchart of information outputting procedure in the information outputting apparatus according to the first embodiment of the present invention.

Firstly, in step S301, listening materials to be played and corresponding scripts are prepared. The synchronization of an audio and/or video stream with a corresponding script is achieved in step S302. The synchronization can be omitted if the stream and the script have already been synchronized when being inputted. Then, in step S303, the script is classified by the script classification unit 206 on the basis of the information classification library in the information classification library storage unit 204. The classification status of each word in the dictionary is determined on the basis of, for example, at least one classification rule.

After the classification, the output of the stream and the processed script based on the classification results in step S303 is performed. Specifically, it is determined in step S304 whether there is any stream to be output. If the playing of the stream has not yet finished, it is determined that there is a stream to be output (“Y” in step S304). If “Y”, the stream and the processed script are output in the output unit 205 in step S305. Initially, the output of the script is performed in the word mode in which only words in the script whose classification status satisfies a predetermined condition are displayed. In the word mode, there may be a plurality of different sub-modes in which different kinds of unfamiliarity words may be displayed. For example, if a familiarity level is set as a classification rule, there may be two sub-modes. One of the two sub-modes is that only words belongs to unfamiliarity level 2 are displayed, and another of the two sub-modes is that words belongs to unfamiliarity levels 1 and 2 are displayed. As a matter of course, the sub-mode may be defined in various manners according to the user's requirements.

During the output of the stream and the processed script, a classification control process of the present invention is performed in step S306.

Details of the classification control procedure will be described with reference to FIG. 6.

FIG. 6 is a flowchart of classification control procedure during the information output procedure in the information outputting apparatus according to the first embodiment.

It is checked whether there is any user input in step S501. If there is no user input (“N” in step S501), the classification control procedure ends. If there is an user input (“Y” in step S501), the classification control unit 206 analyzes the user's input in step S502.

After the analysis in the step S502, the procedure goes to step S503 in which it is determined whether the user's operation is to switch to the whole sentence mode.

If the user's operation is switching to the whole sentence mode (“Y” in step S503), the displaying of the script is switched to the whole sentence mode in step S504 in which the whole sentence corresponding to the displayed words is displayed. In the case that the user still cannot understand the sentence with the prompt of the displayed words, the user can choose to switch to the whole sentence mode so that the whole sentence including the displayed word is displayed in order to facilitate the comprehension of the sentence. Further, in the whole sentence mode, the user can select the words which hinder his comprehension of the sentence, and change the classification status of the words so that the selected words can be displayed in the word mode in the further playing.

In the whole sentence mode, it is determined in step S505 whether the user selects words to change the classification status thereof. If the user selects words to change the classification status thereof (“Y” in the step S505), the classification status of the selected words is changed in the information classification library storage unit 204 (step S506). After a modification of the information classification library in the step S506, the displaying mode is switched back to the word mode in step S507.

If the user does not perform any operation (“N” in step S505), the procedure goes to step S507 to switch the displaying mode back to the word mode. After that, the classification control procedure goes to step S307 shown in FIG. 4 so as to determine whether the information classification library is changed. If the information classification library is not changed (“N” in the step S307), for example, the user does not select a word in the whole sentence mode, then the procedure goes back to the step S304 to continue the output of the stream and processed script as shown in FIG. 4. The operations from the step S304 to the step S307 as shown in FIG. 4 are repeated.

If the information classification library is changed (“Y” in the step S307), then the procedure goes back to the step S303 as shown in FIG. 4 so as to classify again the script based on the changed information classification library. The operations from the step S303 to the step S307 as shown in FIG. 4 are repeated.

If the user's operation is not switching to the whole sentence mode (“N” in the step S503), it is determined whether the user selects a word to change the classification status thereof in the word mode in step S508. If it is determined that the user selects words so as to change the classification status thereof in the word mode (“Y” in step S508), the information classification library is modified by changing the classification status of the selected words in step S509. Then the procedure goes to the step S307 to determine whether the information classification library is changed. Since the information classification library is changed, the procedure goes back to the step S303 as shown in FIG. 4 to classify the script based on the changed information classification library. The operations from the step S303 to the step S307 as shown in FIG. 4 are repeated.

If it is determined that the user does not select words so as to change the classification status thereof in the word mode (“N” in step S508), the procedure goes to the step S307 to determine whether the information classification library is changed. Since the information classification library is not changed, the procedure goes back to the step S304 as shown in FIG. 4 to continue the output of the stream and processed script. The operations from the step S304 to the step S307 as shown in FIG. 4 are repeated.

### Examples of the First Embodiment

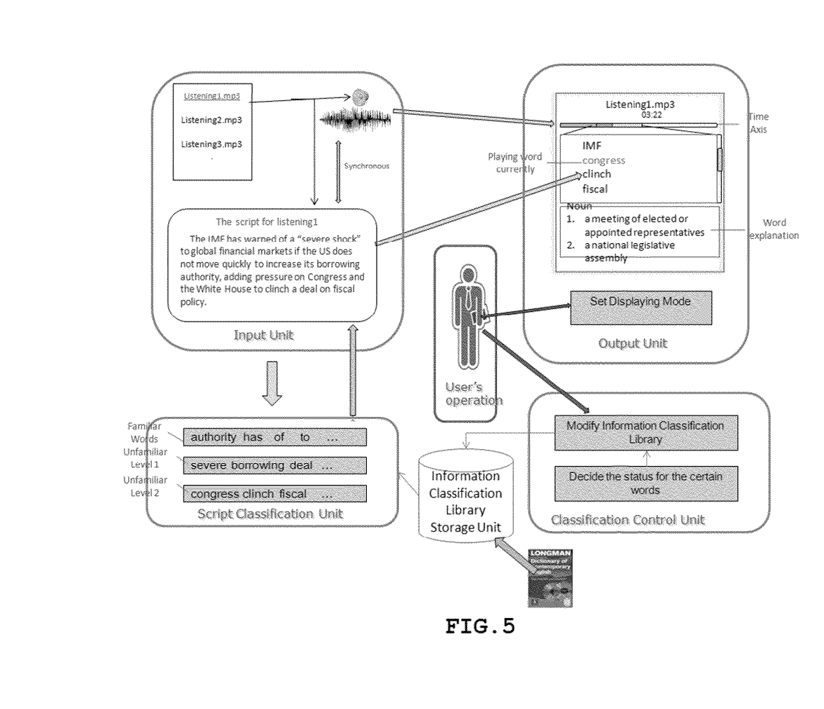

FIG. 5 is a schematic diagram of implementation example of the information outputting procedure according to the first embodiment.

Firstly, listening materials to be played, for example, “Listening1.mp3”, “Listening2.mp3”, “Listening3.mp3”, as well as corresponding scripts are prepared. The synchronization of the listening materials and the scripts is performed. Then, the script is classified by the script classification unit 203 on the basis of the information classification library in the information classification library storage unit 204. “Longman Dictionary of Contemporary English” is taken as an example of the information classification library. The classification status of each word in the dictionary is determined on the basis of, for example, a familiarity level of a word. On the basis of the information classification library, “authority”, “has”, “of”, “to” and so on in the script are classified into familiar words (that is, the words that a user knows their meaning and can understand them through listening), “severe”, “borrowing” and “deal” in the script are classified into the unfamiliarity level 1 (that is, the words that the user knows their meaning but cannot understand them through listening), and “IMF”, “congress”, “clinch” and “fiscal” are classified into the unfamiliarity level 2 (that is, the words that the user neither knows their meaning nor understands them through listening).

Then, the listening material and the processed script on the basis of the above classification results are output in the output unit 205. More specifically, there are two sub-modes to display the processed script on the basis of the classification results. In a first sub-mode of the two sub-modes, when the listening material, for example, “Listening1.mp3”, is played, the words “IMF”, “congress”, “clinch” and “fiscal” belongings to the unfamiliarity level 2 can be displayed, and explanations of the words are displayed so as to facilitate the user's comprehension of the words. In a second sub-mode of the two sub-modes, when the listening material is played, the words belongings to the unfamiliarity levels 1 and 2, “severe”, “borrowing”, “deal”, “IMF”, “congress”, “clinch” and “fiscal” are displayed, and the explanations of the words are displayed. Alternatively, since the user knows the meaning of the words in the unfamiliarity level 1, the explanations thereof may be omitted.

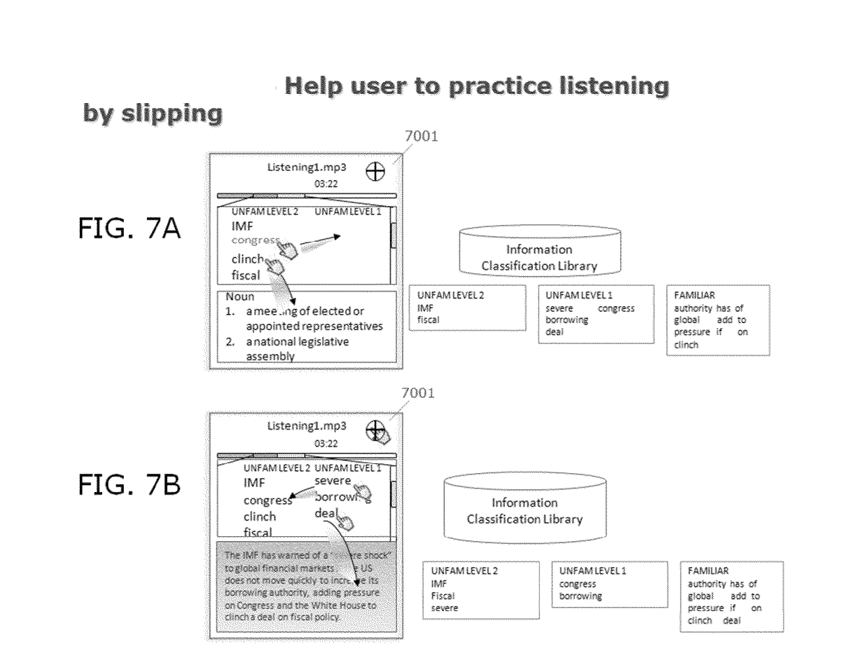

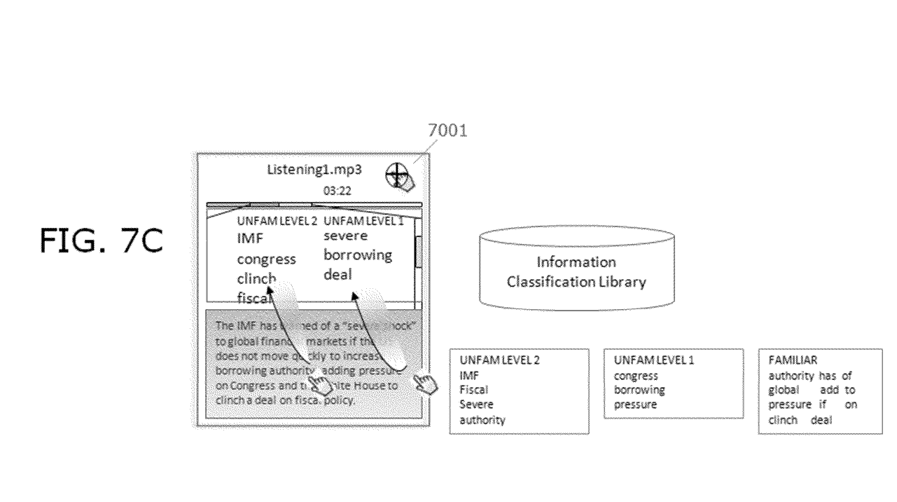

In the example of FIG. 7A, initially, the words belonging to the unfamiliarity level 2 and the explanations thereof are displayed in the first sub-mode. Alternatively, the initial sub-mode of displaying the script may be customized by the user. For example, the words belonging to the unfamiliarity levels 1 and 2 and the explanations thereof may be displayed initially in the second sub-mode. The user may also choose to display initially the complete script.

A display of a certain word starts once a portion in the listening material, which corresponds to the certain word, is played. For example, if a portion in the listening material, corresponding to a word “IMF”, is played, the synchronized word “IMF” starts to be displayed. When a portion in the listening material corresponding to a next unfamiliar word, for example, “congress”, is played, the next unfamiliar word “congress” is displayed from the bottom of a displaying region with the present word “IMF” rolling upwards. Similarly, following words “clinch”, “fiscal” are sequentially displayed from the bottom of the displaying region, with the previous words rolling upwards.

The maximum number of the words that the displaying region is able to display may be set previously to, for example, four words. The maximum number can be set as any number on the basis of the sizes of the displaying region and of the displayed words. If the maximum number is set to four, when the fifth unfamiliar word starts to be displayed at the bottom of the displaying region, the first unfamiliar word disappears at the top of the displaying region, that is, the displaying of the first unfamiliar word ends. In the similar way, once the n-th unfamiliar word starts to be displayed, the (n−4)-th unfamiliar word disappeared at the top of the displaying region, that is, the displaying of the (n−4)-th unfamiliar word ends.

As a matter of course, the starting and ending of displaying unfamiliar words may be implemented in any other manner on the basis of a user's requirement. For example, the starting timing of displaying of an unfamiliar word may be set 1 second after playing of a corresponding portion of the listening material so as to leave some time for the user to think about the word what he/she have listened to before the prompt of the word. The ending timing may be set 5 seconds after the starting of displaying of the unfamiliar word.

If an audio and/or video stream corresponding to a certain word is played, the word is highlighted. The explanation of the word is also displayed. For example, the currently played word “congress” is highlighted and the explanation thereof is displayed.

During the output of the listening materials and the processed scripts, the classification control process is performed by the user's operation. The user's operation includes switching among the first sub-mode, the second sub-mode and the whole sentence mode displaying a whole sentence, as well as modifying the information classification library. Details of the classification control procedure will be described with reference to FIGS. 7A to 7C.

FIGS. 7A to 7C each is a schematic diagram of implementation example of the classification control procedure during the information output procedure in the information outputting apparatus according to the first embodiment.

In each of FIGS. 7A to 7C, the displaying region is separated into two portions. An upper region is for displaying processed scripts. More specifically, the upper region is divided into two sub-regions, a left sub-region is for displaying words belonging to the unfamiliarity level 2 and a right sub-region is for displaying words belonging to the unfamiliarity level 1. In the first sub-mode, only words belonging to the unfamiliarity level 2 are displayed in the left sub-region. In the second sub-mode, words belonging to the unfamiliarity level 2 are displayed in the left sub-region, and words belonging to the unfamiliarity level 1 are displayed in the right sub-region. A lower region is set to display explanation of the currently played word displayed in the upper region in the first sub-mode and the second sub-mode. Alternatively, the lower region may display nothing in the two sub-modes. In this case, upon the user's selecting a word from the displayed words in the upper region, explanation of the selected word can be displayed in the lower region.

In the scenario shown in FIG. 7A, if the user performs a slipping operation on one word, such as the word “congress”, inside the upper region, such slip indicates that the user desires to change the classification status of “congress”. The classification status of the word can be changed from the unfamiliarity level 2 to a familiar word or the unfamiliarity level 1 depending on the user's preference. More specifically, if the user slips rightwards the word “congress”, inside the upper region, such slip indicates that the user desires to change the classification status of the word “congress” from the unfamiliarity level 2 to the unfamiliarity level 1. If the user slips downwards one word, such as the word “clinch”, inside the upper region, such slip indicates that the user desires to change the classification status of the word “clinch” from the unfamiliarity level 2 to a familiar word. If the slip operation is performed, the information classification library is changed by changing the familiarity level of a corresponding word. Since the information classification library is modified, the scripts are classified again based on the modified information classification library. After that, playing of the stream and processed script are continued.

In another aspect, if the user presses in the first sub-mode as shown in FIG. 7A, a knob 7001 in the upper right portion of the displaying region, it indicates that the user desires to switch from the first sub-mode to the second sub-mode so as to display in the upper region the words belonging to the unfamiliarity levels 1 and 2. Then, the words “severe”, “borrowing”, “deal” are displayed in the right sub-region of the upper region so that the user can get further prompt about the sentence, as shown in FIG. 7B.

In the scenario as shown in FIG. 7B, if the user slips leftwards one word, such as the word “severe”, inside the upper region, such slip indicates that the user desires to change the classification status of the word “severe” from the unfamiliarity level 1 to the unfamiliarity level 2. If the user slips downwards one word, such as the word “deal”, inside the upper region, such slip indicates that the user desires to change the classification status of the word “deal” from the unfamiliarity level 1 to a familiar word.

In another aspect, if the user, in the second sub-mode, presses the knob 7001 in the upper right portion of the displaying region, it indicates that the user desires to display in the lower region a whole sentence including the words displayed in the upper region, as shown in FIG. 7C.

More specifically, the sentence including the words “IMF”, “congress”, “clinch” “fiscal”, “severe”, “borrowing” and “shock” is displayed in the lower region of FIG. 7C. In the case, the user may select a word to change its status from familiar to unfamiliar level 1 or 2 through a slip-up operation as shown in the lower region of FIG. 7C. Specifically, in the lower region, the user can select unfamiliar words in the sentence which haven't been shown in the upper region, for example, “authority”, and slip upwards to the left sub-region of the upper region, so that the status of the word can be changed to the unfamiliarity level 2 and the word will be displayed in the left sub-region of the upper region in future. If the user desires to change the word to the unfamiliarity level 1, the user can select unfamiliar words in the sentence which haven't been shown in the upper region, for example, “pressure”, and slip upwards to the right sub-region of the upper region, so that the status of the word can be changed to the unfamiliarity level 1 and the word will be displayed in the right sub-region of the upper region in future. If the classification status of the selected word is changed, the classification status of the word is changed in the information classification library. In this case, the scripts are classified again based on the changed information classification library. After that, playing of the stream and processed script are continued.

In the whole sentence mode, if the user presses the knob 7001, the display returns back to the first sub-mode in which the words belonging to the unfamiliarity level 2 are displayed in the upper region, and the explanations of the words are displayed in the lower region.

Alternatively, in the whole sentence mode, the displaying may return back to the first sub-mode if the user does not select a word any more within a preset time period, for example, 10 seconds.

Alternatively, the user can perform operation through any other peripheral device, for example, a keyboard, a pointing device such as a mouse, or the like.

For the simplicity of the description, the above example is described by utilizing familiarity as a classification rule. In fact, a plurality of classification rules can be used individually or in combination when determining and changing the classification status of a word. For example, with respect to the word “congress”, if a difficulty level is used as the classification rule, the classification status can be initially that the difficult level is 2. During the playing, the classification for the word may be changed to difficult level 1 so that the word will not be displayed. Alternatively, if the field of words is used as the classification rule, the classification status for the word “congress” can initially be that the field is politics and the words in the field of politics are displayed. During the playing, the user may choose not displaying word in the field of politics, thus, the word “congress” will not be displayed. The classification rules may also be utilized in combination. For example, the word “congress” is initially set as difficulty level 2, the field of politics (the words in the field of politics are set to be displayed). During the playing, the user can change the word to difficulty level 1 so that the word will not be displayed, and/or choose not to display words in the field of politics so that the word “congress” will not be displayed.

In the first embodiment of the present invention, the information classification library can be changed real time while the stream and the script are output. More specifically, during the output of the stream, classification status of words can be changed so that the information classification library can be updated. For example, if the user desires to change the status of a displayed unfamiliar word from unfamiliar to familiar, the user can select the word and change it's classification status by a slip-down operation. If the user desires to change the status of a word, which is not displayed in the word mode, the user can make the change by a slip-up operation with respect to the whole sentence displayed in the displaying region. With such real time change of the information classification library, the classification of the words in the script can be changed immediately with reference to the information classification library. A following display of words can be changed accordingly. For example, if the user changes the word “congress” from the unfamiliarity level 2 to unfamiliarity level 1 or a familiar word, the classification status of the same word will be changed in the information classification library. Correspondingly, the same word in the following portion of the script will not be displayed, so that a user need not waste time on looking at the word he has been familiar with. In another aspect, if the user changes the word from the familiar word to unfamiliarity word, the classification status of the same word will be changed in the information classification library. Correspondingly, the same word in the following portion of the script will be displayed, so that a user can comprehend the audio and/or video stream easier with the help of the word being displayed.

### The Second Embodiment

The second embodiment enables the user to make the classification control without using the display screen.

When the user is practicing listening during walking, running, dancing, or the like, it is not convenient for the user to look at the display element so as to customize the script to be displayed on the basis of his requirement. The second embodiment is directed to such situation, and enables the user to customize his script when doing something else such as walking, running, dancing. The language learning can be done without interrupting such thing.

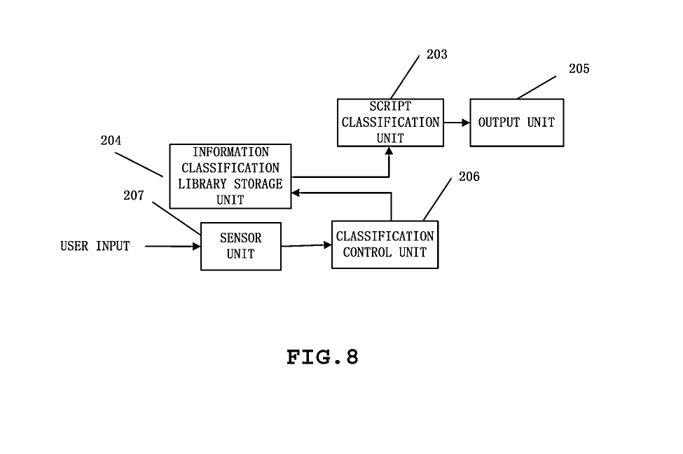

Now, details of achieving the purpose in the second embodiment of the present invention will be described with reference of FIG. 8 to FIG. 10.

FIG. 8 is a block diagram of an information outputting apparatus according to the second embodiment of the present invention. The information outputting apparatus in the second embodiment is the same as that shown in FIG. 3 in the first embodiment, except that the information outputting apparatus of the second embodiment further comprises a sensor unit 207.

The sensor unit 207 detects a user's operation to the apparatus through various ways. For example, the sensor unit 207 can be a vibration sensor which can detect the vibration of the apparatus when the user touches (for example, knocks) the apparatus. Alternatively, the sensor unit 207 can be an accelerometer which can detect the quick movement of the apparatus by the user's operation, such as shaking the apparatus. The sensor unit 207 can be an optical sensor which can detect the change of brightness at a detection region of the apparatus, which is caused by the user's shielding the detection region.

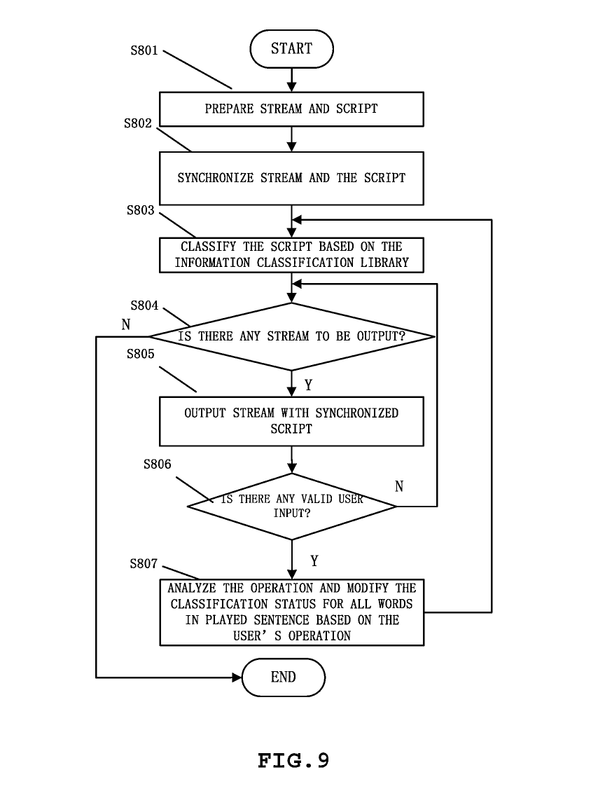

Now, the information outputting procedure in the information outputting apparatus will be described with reference to FIG. 9. Steps S801 to S805 are the same as the step S301 to S305 in FIG. 4 in the first embodiment. The details of the steps S801 to S805 are omitted for simplifying the description.

During the output of the stream and the processed script, it is detected whether there is any user input in step S806. The detection is performed by the sensor unit 206. If no user input is detected or the user input is not a valid operation (“N” in the step S806), the procedure goes back to the step S804 so as to continue the output of the stream and the processed script. If there is a valid user input (“Y” in the step S806), the classification status of all the words in the played sentence are modified on the basis of analysis of the operation in step S807. Such result of analysis may be different based on different types of the user's operation.

After the modification step, the procedure goes back to the step S803 in which the script is classified based on the modified information classification library. After that, the steps S804 to S807 are repeated.

Alternatively, after the modification step, the procedure may go to the step S804 in which the output of the stream and the script is continued without immediately classifying the words in the script. In this case, the classification of the words in the script is not performed immediately when the information classification library is modified, but performed at one time at the end of output of the whole stream. Performing the classification of the script once can save time and improve the efficiency of the apparatus because the classification is not performed in the procedure of playing the stream, but performed after the playing of the stream.

### Example of the Second Embodiment

Now, a vibration sensor is considered as an example of the sensor unit 207, so as to exemplify the classification control procedure in the second embodiment.

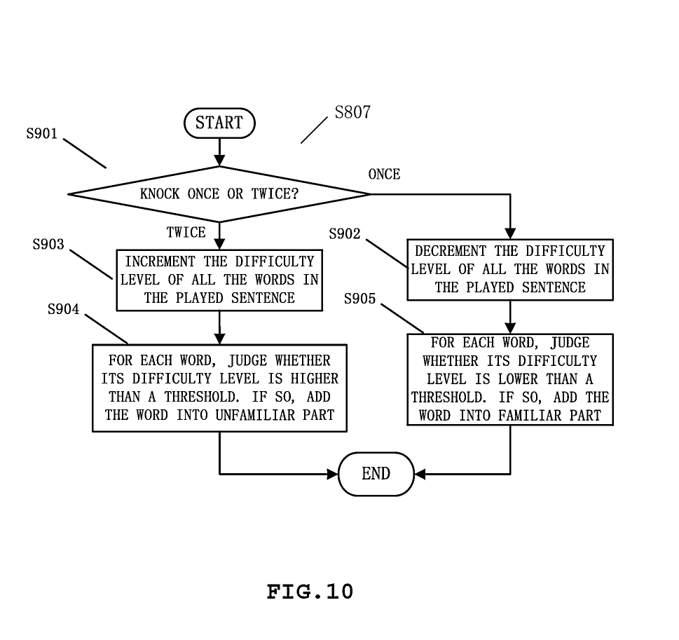

FIG. 10 is a flowchart of an implementation example of the classification control procedure with the vibration sensor. During the output of the stream and the processed script in the information output apparatus, it is detected whether there is an operation of the user's knocking the apparatus. If the user knocks the apparatus, it is determined whether the user knocks the apparatus once or twice in step S901.

More specifically, when the user knocks the apparatus once (“ONCE” in step S901), the difficulty level for each of the words within the current displayed sentence is decremented (step S902). For each of the words in the sentence, it is determined whether the difficulty level of the word is lower than a threshold. When the difficulty level for the word is lower than the threshold, the classification status of the word is changed to familiar, so that the word will not be displayed in the further usage of the information outputting apparatus (step S905). After that, the playing of the stream is continued.

In another aspect, when the apparatus is knocked twice, the difficult level for the words within current played sentence will be incremented (step S903). For each of the words in the sentence, it is determined whether the difficulty level of the word is higher than the first threshold. When the difficult level for the word is higher than the first threshold, the classification status of the word is changed to unfamiliar level 1(step S904), so that the same word will be displayed as a word in the unfamiliarity level 1 in the further usage of the information outputting apparatus. When the difficult level is further incremented to be higher than a second threshold which is higher than the first threshold, the classification status of the word is changed to the unfamiliarity level 2, so that the same word will be displayed as a word in the unfamiliarity level 2 in the further usage of the information outputting apparatus. After that, the playing of the stream is continued.

As shown in FIG. 9, the classification of the words in the script can be performed during the playing. Alternatively, the classification of the words in the script is performed at one time after the playing of all the streams are completed, on the basis of the modification of the information classification library.

In the above examples of the second embodiment, in the information classification library storage unit, each word is classified by its difficult level. During playing of the audio and/or video stream, if the user thinks that he has already understood the sentence he is listening, he can knock the apparatus once. The difficulty level for each of the words within the current displayed sentence will be decremented. When the difficult level for the word is lower than a first threshold, the classification status of the word is changed to familiar, so that the word will not be displayed in the further usage of the information outputting apparatus. In another aspect, when a user thinks that he cannot understand the sentence he is listening, he may knock the apparatus twice. The difficult level for each of the words within current played sentence will be incremented. When the difficult level for the word is higher than the first threshold, the classification status of the word is changed to unfamiliar level 1, so that the same word will be displayed as a word in the unfamiliarity level 1 in the further usage of the information outputting apparatus. When the difficult level is further incremented to be higher than the second threshold which is higher than the first threshold, the classification status of the word is changed to the unfamiliarity level 2, so that the same word will be displayed as a word in the unfamiliarity level 2 in the further usage of the information outputting apparatus.

The above example describes the vibrator sensor.

If the sensor unit 207 is the accelerator, it is determined whether the user shakes the apparatus once or twice so as to make modification (classification control).

As a matter of course, the modification may be performed in any other manner. For example, shaking or knocking the apparatus three times and four times are valid operations.

Further, the modification may be performed through utilizing other kinds of sensors, such as the optical sensor.

For the simplicity of the description, the above example is described by utilizing the difficulty level as a classification rule. In fact, a plurality of classification rules can be used individually or in combination when determining and changing the classification status of a word.

In the second embodiment, the classification control procedure can be performed without using the displaying element, so that the user can customize his script when doing any other thing such as walking, running, dancing, or the like. The language learning can be done without interrupting such other thing.

### Third Embodiment

In the previous embodiments, during the playing of the stream or after the playing, the classification of the script is executed on the modified information classification library in the information classification library storage unit. Alternatively, the classification of the script during the playing can be done directly on the basis of the user's operation.

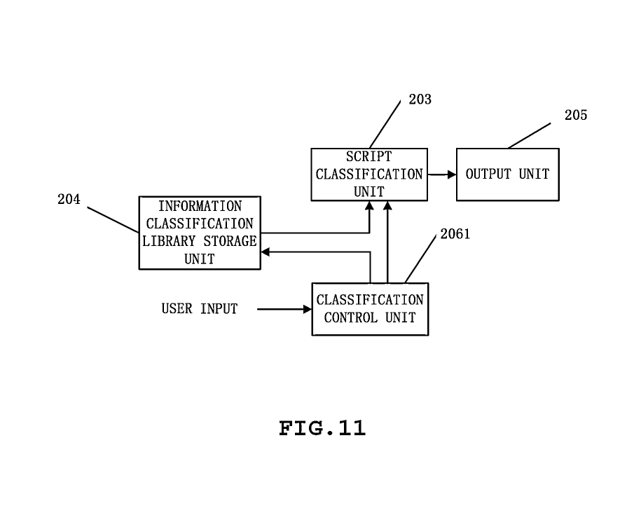

FIG. 11 is a function block diagram of an information outputting apparatus according to the third embodiment of the present invention. The information outputting apparatus in the third embodiment is the same as that shown in FIG. 3 in the first embodiment, except that the classification control unit 2061 can control the script classification unit 203 directly.

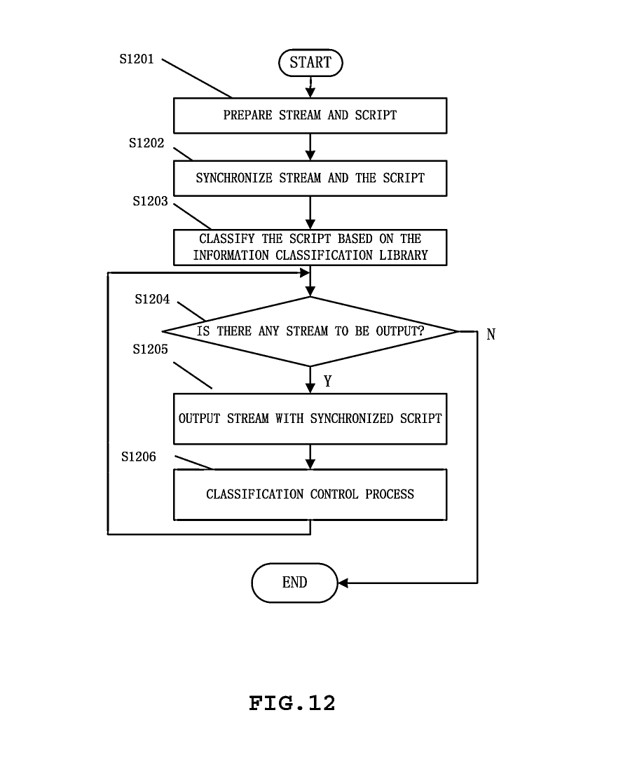

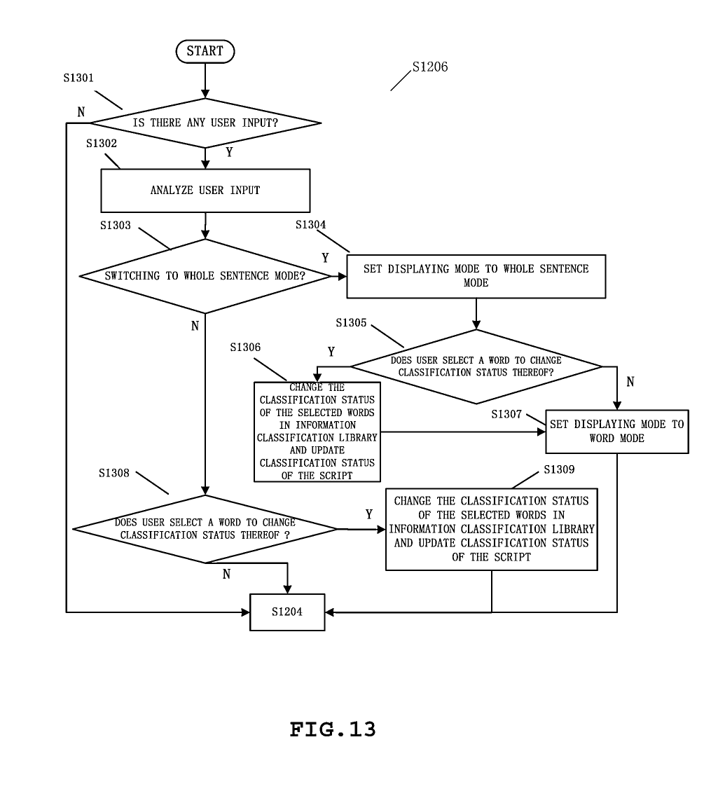

In the case that the classification control procedure is perform through the display element, details of changing the classification status of the script will be described with reference to FIGS. 12 and 13. FIG. 12 is a flowchart of information outputting procedure in the information outputting apparatus according to the third embodiment of the present invention. FIG. 13 is a flowchart of information classification procedure in the information outputting procedure according to the third embodiment.

In FIG. 12, steps S1201 to S1205 are the same as the steps S301 to S305 shown in FIG. 4 in the first embodiment. The details of the steps S1201 to S1205 are omitted for simplifying the description. As shown in FIG. 12, during the output of the stream and the corresponding script, the classification control procedure in step S1206 is performed. The difference of the step S1206 from the step S306 is that the former has the classification of the script updated directly on the basis of the user's input, rather than the modified information classification library. Details of the step S1206 is shown in FIG. 13. The steps S1301 to S1305 and the steps S1307 and S1308 are the same as the step S501 to S505 and the steps S507 and S508 shown in FIG. 6 in the first embodiment. The details of the steps S1301 to S1305 and the steps S1307 and S1308 are omitted for simplifying the description. One of differences lies in that when the user selects a word in the whole sentence mode in the step S1305, besides the modification of the information classification library, the classification status of the same word throughout the script will be changed (S1306).

For example, if the user's operation is switching to the whole sentence mode and slipping up a word from the lower region into the upper region as shown in FIG. 7C, the classification status of the same word in the sentence and in the other portion of the script will be changed directly from familiar to unfamiliar.

Another difference lies in that when the user selects a word to change its classification status in the step S1308, besides the modification of the information classification library, the classification status of the same word throughout the script will be changed to unfamiliar (S1309).

For example, if the user's operation is slipping down a word from the upper region as shown in FIG. 7A, the classification status of the same word in the sentence and in other portion of the script will be changed directly from unfamiliar to familiar.

The above description with reference to FIGS. 11 and 13 is directed to the direct classification control of the script using the display element.

In the case that the direct classification control of the script is performed without the displaying element, if the user's operation is to modify the classification status of the words in one whole sentence, the classification status of the words in other portion of the script will also be modified immediately.

For example, if the user's operation is to decrease the difficulty level of each word in the whole sentence, the difficulty level of each word in other part of the script is also decremented immediately. When the difficult level of the word is lower than a first threshold, the classification status of the word is changed to familiar, so that the same word throughout the script will not be displayed in the further playing. Similarly, if the user's operation is to increment the difficulty level of each word in the whole sentence, the difficulty level of each word in other part of the script is also incremented immediately. When the difficult level of a word is higher than the first threshold, the classification status of the word is changed to unfamiliar level 1, so that the same word throughout the script will be displayed as a word in the unfamiliarity level 1 in the further playing. When the difficult level is further incremented to be higher than a second threshold which is higher than the first threshold, the classification status of the word is changed to the unfamiliarity level 2, so that the same word throughout the script will be displayed as a word in the unfamiliarity level 2.

With such direct classification of the script during the playing, the time taken in the classification control can be reduced since it is unnecessary to search the modified information classification library so as to determine the classification status of the words in the script.

### Fourth Embodiment

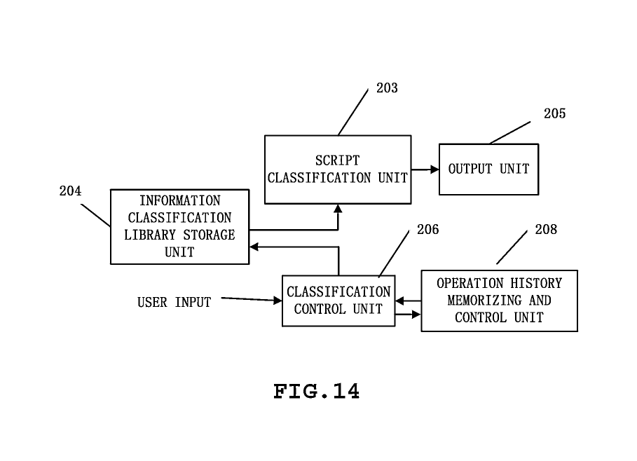

FIG. 14 is a function block diagram of an information outputting apparatus according to a fourth embodiment of the present invention.

The information outputting apparatus of the fourth embodiment is the same as that in the first embodiment, except that an operation history memorizing unit 208 is provided for memorizing a user's operation history which provides an undo operation for a certain record in the user's operation history.

In the control of the classification control unit 206, once a classification modification operation is performed, such operation is recorded in the classification operation history memorizing unit 208. When the user wants to cancel a classification modification operation, the user may perform an operation to instruct the classification control unit 206 to cancel the operation. The classification control unit 206 may refer to the operation history stored in the operation history memorizing unit 208 and perform the undo operation for the corresponding operation record in the user's operation history.

In view of the fourth embodiment, if the user desires to cancel a classification control operation in the past, so as to change the classification status of a certain word back to its previous classification status, the user may retrieve the operation history so as to cancel the classification control operation. For example, during the process of playing the stream and displaying the script, if the user makes a wrong operation or the apparatus misunderstands the user's operation in the classification control procedure, the operation can be cancelled, so as to correct a wrong classification control operation.

It is possible to carry out the method and system of the present invention in various ways. For example, it is possible to carry out the method and apparatus of the present invention through software, hardware, firmware or any combination thereof. The above-described order of the steps for the method is only intended to be illustrative, and the steps of the method of the present invention are not limited to the above specifically described order unless otherwise specifically stated. Besides, in some embodiments, the present invention may also be embodied as programs recorded in recording medium, including machine-readable instructions for implementing the method according to the present invention. Thus, the present invention also covers the recording medium which stores the program for implementing the method according to the present invention.

Although some specific embodiments of the present invention have been demonstrated in detail with examples, it should be understood by a person skilled in the art that the above examples are only intended to be illustrative but not to limit the scope of the present invention. It should be understood by a person skilled in the art that the above embodiments can be modified without departing from the scope and spirit of the present invention. The scope of the present invention is defined by the attached claims.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information outputting apparatus for outputting a first information, and a second information including a plurality of information units, comprising:
storage means operable to store an information classification library including a plurality of the information units and a classification status for each of the information units;
classification means operable to determine the classification status of each information unit in the second information according to the information classification library;
output means operable to synchronically output the first information and the information units in the second information based on the classification results in said classification means; and
classification control means operable to change real time the classification status for at least one information unit in the information classification library while the first information is output.

2. The information outputting apparatus according to claim 1, wherein,
the classification control means operable to change the classification status for at least one information unit in the second information based on the changed information classification library, while the first information is output.

3. The information outputting apparatus according to claim 1, wherein,
the classification control means operable to change directly the classification status for at least one information unit in the second information while the first information is output.

4. The information outputting apparatus according to claim 1, wherein,
the classification control means operable to change real time the classification status for at least one information unit in the information classification library according to a user's operation while the first information is output.

5. The information outputting apparatus according to claim 1, wherein,
the classification status for each information unit includes at least one of: a difficulty level, and a familiarity level of the information unit, and the output means only outputs information units each having the difficulty level or familiarity level larger than a threshold,
the classification control means operable to change real time the classification status for an information unit according to a user's operation of increasing/decreasing the difficulty level or familiarity level of an information unit, and the output of the output means is changed correspondingly.

6. The information outputting apparatus according to claim 1, wherein,
the classification status for each information unit includes at least one of: part of speech, and field of the information unit, and the output means only outputs information units each belonging to a certain part of speech or belonging to a certain field,
the classification control means operable to change real time the classification status for the information unit according to a user's operation of selecting the part of speech or the field, and the output of the output unit is changed correspondingly.

7. The information outputting apparatus according to claim 1, wherein,
the first information is an audio information and/or a video information, the second information is a script corresponding to the first information, which includes at least one sentence comprised of the information units each being a character, a word, or a phrase.

8. The information outputting apparatus according to claim 7, wherein,
the output means comprises a first displaying region for displaying the information units in the second information based on the classification results of the classification means, and a second displaying region capable of switching between a mode in which an explanation of the displayed information unit in the first displaying region is displayed and a mode in which a sentence including the displayed information unit is displayed, and
the classification status for the information unit is changed by the user's adding/erasing the information unit to/from the first displaying region.

9. The information outputting apparatus according to claim 8, wherein,
the displaying of the information units in the second information starts at or after a timing that a corresponding part of the first information is played.

10. The information outputting apparatus according to claim 8, wherein,
in a whole sentence mode of the output means, at least one information unit can be selected by a user in the second displaying region so as to be added to the first displaying region.

11. The information outputting apparatus according to claim 6, wherein,
the user's operation includes at least one of: shaking, knocking and shielding the information outputting apparatus, and the number of times of the user's operation is analyzed by a sensor to change the classification status for the information unit.

12. The information outputting apparatus according to claim 4, further comprising operation history memorizing means for memorizing a user's operation history, and the classification control means operable to provide an undo operation for a certain record in the user's operation history of the operation history memorizing means.

13. The information outputting apparatus according to claim 8, wherein, in the mode in which an explanation of the displayed information unit in the first displaying region is displayed, a plurality of different sub-modes can be switched in which different kinds of the information units are displayed on the basis of the classification results.

14. A method for outputting a first information and a second information including a plurality of information units through an information outputting apparatus, comprising:
classification step of determining a classification status of each information unit in the second information according to an information classification library which includes a plurality of the information units and a classification status for each of the information unit;
outputting step of synchronically outputting the first information and the information units in the second information based on the classification results of said classification step; and
classification control step of changing real time the classification status for at least one information unit in the information classification library while the first information is output in the outputting step.

15. The method according to claim 14, wherein,
the classification control step further comprising changing the classification status for at least one information unit in the second information based on the changed information classification library, while the first information is output in the outputting step.

16. The method according to claim 14, wherein,
the classification control step further comprising changing directly the classification status for at least one information unit in the second information while the first information is output in the outputting step.

17. The method according to claim 14, wherein,
the classification control step further comprising changing real time the classification status for at least one information unit in the information classification library according to a user's operation while the first information is output in the outputting step.

18. The method according to claims 14, wherein,
the classification status for each information unit includes at least one of: a difficulty level, a familiarity level of the information unit, and information units each having the difficulty level or familiarity level larger than a threshold are output in the outputting step,
in the classification control step, the classification status for the information unit is changed real time according to a user's operation of increasing/decreasing the difficulty level or the familiarity level of the information unit, and the output in the outputting step is changed correspondingly.

19. The method according to claim 14, wherein,
the classification status for each information unit includes at least one of: part of speech, and field of the information unit, and only information units each belonging to a certain part of speech or belonging to a certain field are output in the outputting step,
in the classification control step, the classification status for the information unit is changed real time according to the user's operation of selecting the part of speech or the field, and the output in the outputting step is changed correspondingly.

20. The method according to claim 14, wherein,
the first information is an audio information and/or a video information, the second information is a script corresponding to the first information, which includes at least one sentence comprised of the information units each being a character, a word, or a phrase.

21. The method according to claim 20, wherein,
the information outputting apparatus comprising a first displaying region and a second displaying region,
in the outputting step, the information units in the second information is displayed in the first displaying region based on the classification results in the classification step, and a mode in which an explanation of the displayed information unit in the first displaying region is displayed and a mode in which a sentence including the displayed information unit is displayed are switched in the second displaying region, and
the classification status for the information unit is changed by the user's adding/erasing the information unit to/from the first displaying region.

22. The method according to claim 21, wherein,
the displaying of the second information unit starts at or after a corresponding part of the first information is played.

23. The method according to claim 21, wherein,
in a whole sentence mode, at least one information unit can be selected by a user in the second displaying region so as to be added to the first displaying region.

24. The method according to claim 18, wherein,
the user's operation includes at least one of:
shaking, knocking and shielding the apparatus, and the number of times of the user's operation is analyzed by a sensor to change the classification status for the information unit.

25. The method according to claim 17, further comprising operation history memorizing and control step for memorizing a user's operation history and providing an undo operation for a certain record in the user's operation history.

26. The method according to claim 21, wherein, in the mode in which an explanation of the displayed information unit in the first displaying region is displayed, a plurality of different sub-modes can be switched in which different kinds of the second information units are displayed on the basis of the classification results.
